(19) United States
(12) Patent Application Publication
(10) Pub. No.: US 2009/0058051 A1
(43) Pub. Date: Mar. 5, 2009

(54) Curtain Airbag

(76) Inventors: Mark Hatfield, Providence, UT (US); Ian Taylor, Cheshire (GB); Alan Bradburn, Stoke on Trent (GB)

Correspondence Address: AUTOLIV ASP INC, 3350 AIRPORT ROAD, OGDEN, UT, 84405, US

(21) Appl. No.: 11/849,441

(22) Filed: Sep. 4, 2007

(51) Int. Cl. B60R 21/16

(52) U.S. Cl. 280/729

(57) ABSTRACT

In order to provide a curtain airbag that is of light weight, that is less expensive and easy to manufacture and that protects securely body parts from coming into a position outside the car, the invention refers to a curtain airbag which comprises a first section having two side walls enclosing a first gas chamber, a second section having two side walls enclosing a second gas chamber, a tube made of a flexible material extending between the first and the second section and connecting the first gas chamber with the second gas chamber and a non-inflatable intermediate section connecting the first and the second section and being connected to the first section by a first seam, to the second section by a second seam, and to the tube by a third seam.

### FIELD OF THE INVENTION

The present invention relates generally to a curtain airbag for installation into a motor vehicle, especially for installation into a passenger car. Particularly the invention relates to a curtain airbag having at least two gas chambers being connected by a tube made of a flexible material extending between a first and a second gas chamber.

### THE BACKGROUND OF THE INVENTION

Curtain airbags are widely used in passenger cars. In a mounted and non-inflated state such a curtain airbag is fixed to the inner structure of the car in the area of the roof bar and extends in general along the entire roof bar. In inflated state the curtain airbag covers the side-windows and (if present) the B-pillar. In general it is not necessary that gas chambers are provided along the whole area of the side-windows. It is known to provide at least two gas chambers which are separated from one another by a non-inflatable intermediate section. In this case a first gas chamber is assigned to the front passenger or driver and the second gas chamber is assigned to the rear passenger. For larger vehicles with three seat rows it known to provide a third gas chamber for the third seat row.

Often, the curtain airbag is made of a single material, namely a woven plastic material. In order to achieve the desired gas tightness this woven material must be rather thick or coated which makes the curtain airbag heavy and expensive.

From U.S. Pat. No. 6,883,827 it is known to provide a curtain airbag with separate sections each having a gas chamber. Said sections are connected by tube elements and flexible straps. The tube elements serve for filling all gas chambers by a single gas generator and the straps serve for keeping the whole curtain airbag in position. Consequently, there exist hollow spaces between the sections and there is the risk that during an accident body parts of a passengers or the driver come into a position outside the car if the side windows are open.

From the WO 2006/74814 A1 a similar curtain airbag is known. Here, a non-inflatable intermediate section with a large surface is disposed between a first and a second section. Nevertheless there is a risk that a body part, especially an arm penetrates between the non-inflatable intermediate section and the tube connecting first and the second gas chamber. Further, this curtain airbag is rather complicated to manufacture.

Given the foregoing, it would be desirable to provide a curtain airbag that protects body parts securely from coming into a position outside the car, which is of light weight, and which is easy and of low cost to manufacture.

### SUMMARY OF THE INVENTION

The present invention relates to an improved curtain airbag that is of light weight, that is low cost and easy to manufacture and that protects securely body parts from coming into a position outside the car, so called ejection mitigation.

The curtain airbag of the present invention comprises a first section having two side walls enclosing a first gas chamber and a second section having two side walls and enclosing a second gas chamber. A tube made of a flexible material extends between these two sections and connects the first gas chamber with the second gas chamber. A non-inflatable intermediate section connects the first and the second section and is sewn to the first section by a first seam and to the second section by a second seam. Further, said non-inflatable intermediate section is sewn to the tube by a third seam. Consequently, it is possible to select a suitable material for each functional part. Especially for the first and the second section as well as for the tube, a gas tight and rather heavy material can be chosen while for the non-inflatable intermediate section a light weight and less expensive material is preferred. Nevertheless, the inflated airbag constitutes a closed surface so that no body parts can project through this curtain airbag.

In a preferred embodiment the tube is being made of at least one cutting and being closed by at least one tube closing seam. Manufacturing that tube from a cutting makes the manufacture easy and cost effective. Especially the material of said cutting can be the same material as the material the first and the second section are made from. Even more preferred the third seam connecting the non-inflatable intermediate section and the tube closing seam are the same seam. This helps making the manufacture cost effective and easy. Even more preferred first seam, second seam and third seam are sections of a single seam that can be sewn in a single step.

Often, it is preferred that the first and second gas chamber are filled simultaneously and not one after the other. In order to achieve this, the gas generator must be placed between these two gas chambers, this is between first and second section of the curtain airbag. So, in a further preferred embodiment a receiving section for receiving a gas generator extends from the tube. Even more preferred said receiving section and said tube are made of a single cutting leading to a high degree of integrity and gas tightness. Still further preferred this cutting is H-shaped. In order to protect that cutting from gas streaming out of the gas generator a reinforcement layer can be provided.

In an alternative embodiment the tube for the cutting is not H-shaped. Here it is of rectangular shape and shows a longitudinal slit. This slit is necessary in order to achieve an easy assembly as will be described later in greater detail. If in this case a gas generator is to be attached to the tube a separate receiving cutting is provided and attached to a non-flit area of the tube. Said receiving cutting is forming the receiving section.

In both cases the tube shows an open longitudinal edge in a pre-assembled state. In order to achieve an easy manufacturing process this open longitudinal edge is closed after the tube has been connected to the first and the second section.

The invention will now be described in detail by ways of preferred embodiments in view of the attached figures. In the figures:

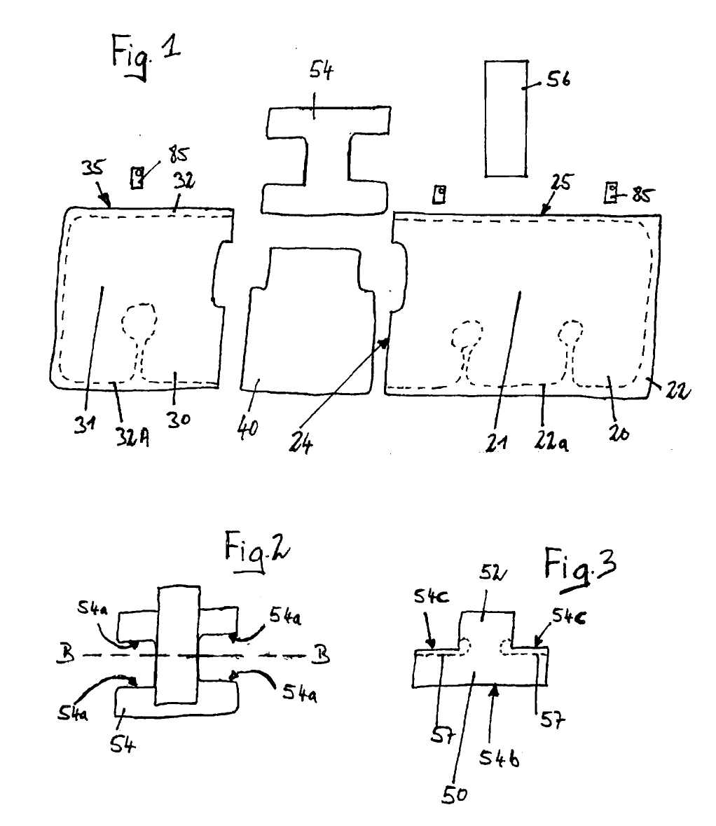

FIG. 1 shows the parts to be assembled to a curtain airbag according to a first embodiment of the invention;

FIG. 2 shows the H-shaped cutting and the reinforcement layer shown in FIG. 1 after a first assembly step;

FIG. 3 shows the parts of FIG. 2 after a second assembly step;

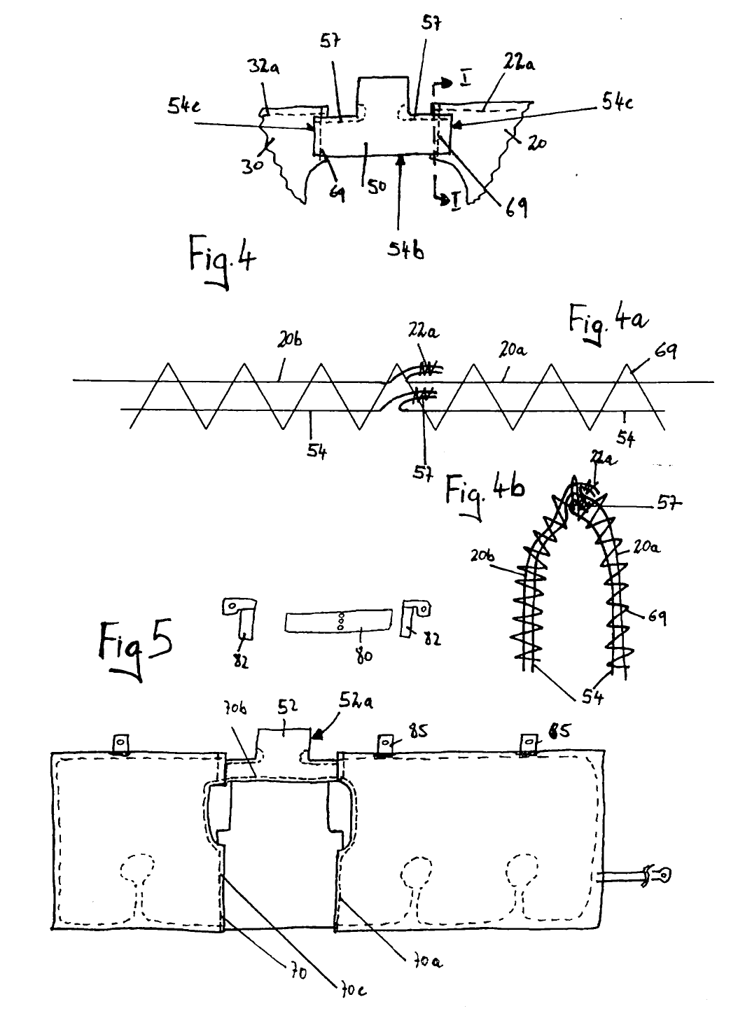

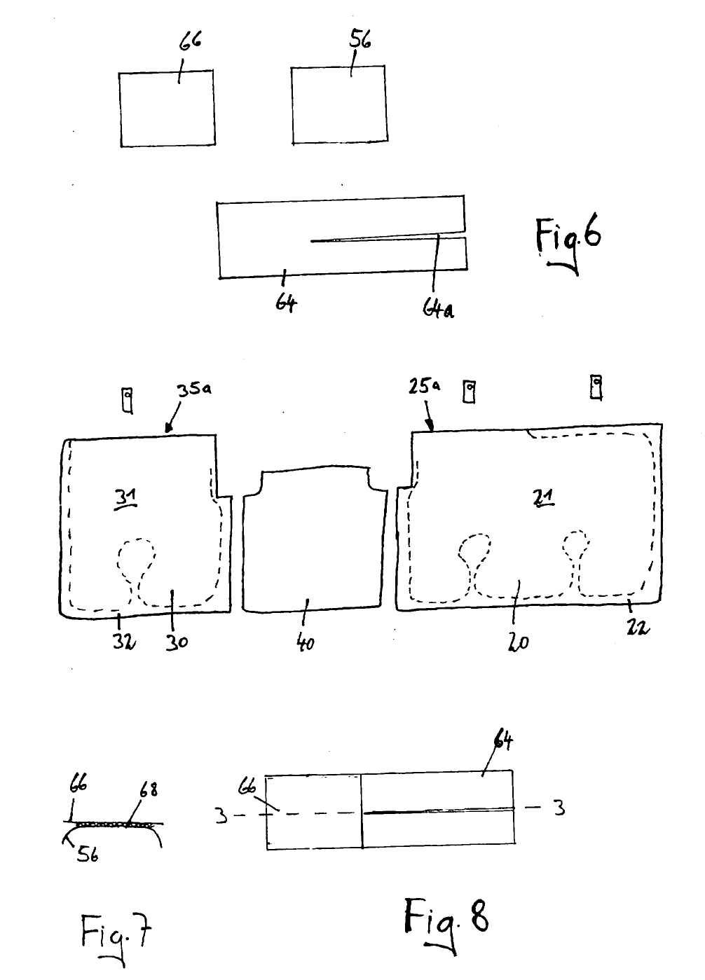

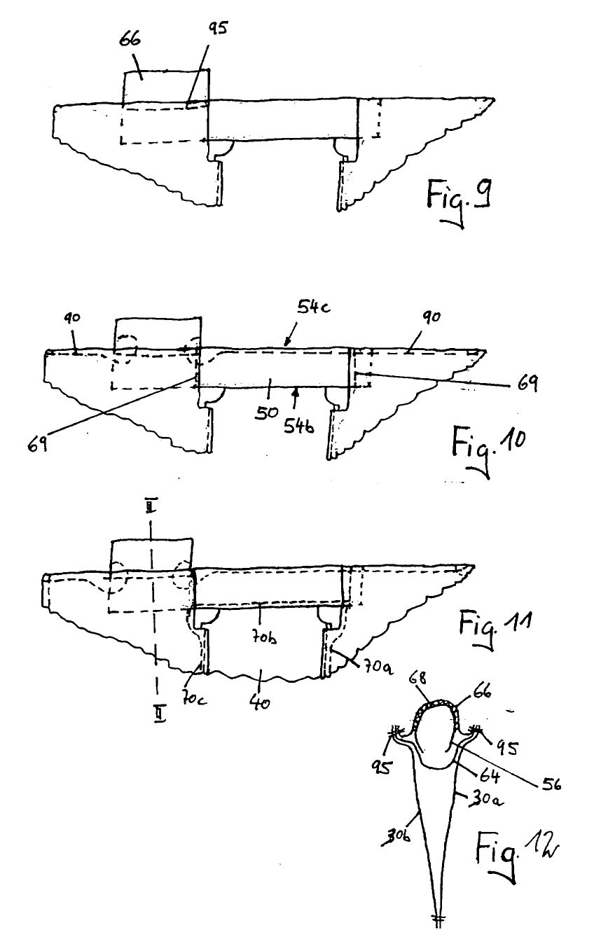

FIG. 4 shows the tube of FIG. 3 connected to the first and the second section;

FIG. 4a shows how the tube is being sewn to the first section;

FIG. 4b shows a sectional view along line I-I of FIG. 4;

FIG. 5 shows a completely assembled curtain airbag according to the first embodiment of the invention and a gas generator and attachment brackets to be used together with this curtain airbag;

FIG. 6 shows the parts to be assembled to a curtain airbag according to a second embodiment of the invention;

FIG. 7 shows the additional cutting and the reinforcement layer of FIG. 6 glued together;

FIG. 8 shows the tube in a pre-assembled state;

FIG. 9 shows the tube inserted into first and second section;

FIG. 10 shows the tube inserted into first and second section and secured to first and second section via tube connecting seams 69 and after applying upper seams;

FIG. 11 shows the tube completely connected to the first and the second section;

FIG. 12 shows an intersection along plane II-II in FIG. 9.

FIG. 1 shows the parts to be assembled to the curtain airbag according the first embodiment of the invention. A first section 20 and a second section 30 are provided, said two sections comprising two side-walls enclosing a first gas chamber 21 and a second gas chamber 31 respectively. The two side-walls of first section 20 are connected along a closed edged 22. This can be achieved by sewing, gluing or welding two separate cuttings along a connecting line 22A or by manufacturing the first section 20 as a one piece woven (OPW) element. The middle edge 24 of the first section 20 is open. The second section 30 is made the same way as first section 20. It comprises two side-walls enclosing a second gas chamber 31, said two side-walls being connected via closed edged 32. The middle edge 34 of second section 30 is open. Preferably, first and second sections 20, 30 consist of a woven material. A coating leading to a higher gas tightness might be provided.

An intermediate section 40 is provided for connecting first and second section 20, 30. Said intermediate section 40 does not comprise a gas chamber, consequently it only needs a single layer. Preferably, this intermediate section 40 is made of a light material, for example a foil or uncoated light fabric.

In assembled state the two gas chambers 21, 31 are connected via a tube. In this embodiment a receiving section extends from this tube. This tube and receiving section are made from a H-shaped cutting 54 and a reinforcement layer 56. The assembly of the tube is now explained:

As shown in FIG. 2 in a first step the reinforcement layer 56 is placed on the “crossbar” of H-shaped cutting 54. In a next step H-shaped cutting 54 is bent along bending line B and the inner edges 54a of H-shaped cutting 54 are sewn together via upper seams 57. The U-shaped ends of upper seams 57 also fix the reinforcement layer 56 to the H-shaped cutting 54. By applying the upper seam 57 to the inner edges 54a one comes to the part as shown in FIG. 3. The inner edges 54a of the H-shaped cutting form the upper edges 54c of the tube 50. This part comprises a tube 50 which is still open on its lower edge 54b, and a receiving section 52.

In a next step, the tube 50 is connected to the first and the second section 20, 30. This connection is made by tube connecting seams 69. Since one longitudinal edge, namely the lower edge 54b, of tube 50 and the middle edges 24, 34 of first and second section 20, 30 are open at this stage of assembly, it is easy to apply these seams 69. They can be sewn in a flat position as shown in FIG. 4a which is a sectional view in the plane of line I-I of FIG. 4 during sewing. After bending back the tube and the first and the second side wall 20a, 20b, one comes to the configuration as shown in FIG. 4b, which is a section along line I-I in FIG. 4. One can see that the tube connecting seams 69 do not close the front side of tube 50.

In a last step, the connecting and closing seam 70 is applied. This connecting and closing seam 70 has three sections namely the first seam section 70a, the second seam section 70c and the third seam section 70b. The first seam section 70a closes the open middle edge 24 of first section 20 and connects the intermediate section 40 to said first section. The third seam section 70b closes the lower edge of tube 50—therefore it is the tube-closing seam—and connects the intermediate section 40 to said tube 50. Finally, the second seam section 70c closes the open middle edge 34 of second section 30 and connects the intermediate section 40 to said second section (FIG. 5).

FIG. 5 also shows a gas generator 80 and attachment brackets 82. To complete the curtain airbag assembly the gas generator 80 is inserted into an opening 52a of the receiving section 52 so as to extend through said receiving section 52. The attachment brackets 82 serve for fixing the gas generator to the curtain airbag 10 as well as fixing said gas generator to the inner structure of a vehicle.

The FIGS. 6 to 12 show a second preferred embodiment of a curtain airbag according to the invention.

FIG. 6 shows the parts of a curtain airbag according to a second embodiment of the invention. As in the first embodiment, the curtain airbag comprises a first section 20 and a second section 30 both sections consisting of two side walls enclosing a first gas chamber 21 and a second gas chamber 31 respectively. As in the first embodiment, the two sections 20, 30 each have a closed edge 22, 32 and an open edge. The open edges are provided on the upper edges and have the reference numbers 25a and 35a. The intermediate section 40 has basically the same shape as the intermediate section of the first embodiment and is also comprised by a single layer of a flexible material. The tube for connecting the gas chambers 31, 31 is made from a rectangular cutting 64 having a longitudinal slit 64a. An additional cutting 66 for forming the receiving section 52 and a reinforcement layer 56 are also provided.

As is shown in FIG. 7, in a first assembly step the additional cutting 66 and the reinforcement layer 56 are connected to each other by means of a layer of glue 68. Then, the additional cutting 66 is placed onto the non-slit section of the rectangular cutting 64 such that the reinforcement layer 56 is placed between the rectangular cutting 64 and the additional cutting 66 leading to a part as shown in FIG. 8.

Now, the sub-assembly as shown in FIG. 8 is folded along the line 3-3 in FIG. 8 such that the slit 64a points downwardly and the additional cutting 66 forming the receiving section points upwardly. In this position, this sub-assembly is inserted into the open edges 25, 35 of a first and second section 20, 30, as shown in FIG. 9.

In the following steps the curtain airbag is finished: First, the seams 95 connecting the additional cutting the rectangular cutting 64 and the side walls 30a, 30b are sewn. Second, the tube connecting seams 69 are added in the same way as in the first embodiment. Since the lower edge 54b of the tube 50 is open at this stage, The tube closing seams 69 can be sewn in a “flat condition” similarly as shown in FIG. 4b. Then, upper seams 90 closing the open edges 25, 35 of first and second section 20, 30 and the upper edge 54c of tube 50 are applied. After adding these seams, the situation as shown in FIG. 10 is reached.

Finally, a connecting and closing seam 70 as shown as in the first embodiment is added. The first seam section 70a connects the first section 20 to the intermediate section 40, closing seam section 70b closed the tube 50 and connects intermediate section 40 to the tube 50 and second seam section 70c connects the intermediate section 40 to the second section 30. FIG. 11 shows the finished curtain airbag. FIG. 12 is a sectional view along line II-II of FIG. 11.

The seams can be sewn seams or other seams, like welded seams. If sewn seams are used, it might be necessary to take additional measures in order to achieve a higher gas-tightness, depending on the application. If the curtain airbag is only for protection during a side impact, there is generally no need for additional gas-tightening. If, however the curtain airbag is also for protection during a roll-over accident, the curtain airbag must keep its pressure for up to six seconds. In this case, sewn seams need sealing. Such a sealing can be provided in form of an adhesive applied between the material layers before sewing or on the outside after sewing. Especially silicone can be used as an adhesive.

### REFERENCE NUMBERS

10 Airbag
12 attachment tab
14 positioning strap
20 first section
20a first side wall
20b second side wall
21 first gas chamber
22 closed edge of first section
24 middle edge of first section
25 upper edge
25a open upper edge
30 second section
30a first side wall
30b second side wall
31 second gas chamber
32 closed edge of second gas chamber
34 middle edge of second gas chamber
35 upper edge
35a open upper edge
40 intermediate section
50 tube
52 receiving section
52a opening
54 H-shaped cutting
54a inner edge
54b lower edge
54c upper edge
56 reinforcement layer
57 upper seam
64 rectangular cutting
64a slit
66 additional cutting
68 glue
69 tube connecting seam
70 connecting and closing seam
70a first seam section
70b closing seam section
70c second seam section
80 gas generator
82 attachment bracket
85 tab
90 upper seam
95 seam

1. Curtain airbag comprising:
a first section having two side walls enclosing a first gas chamber;
a second section having two side walls enclosing a second gas chamber.
a tube made of a flexible material extending between the first and the second section and connecting the first gas chamber with the second gas chamber.
a non-inflatable intermediate section connecting the first and the second section and being connected to the first section by a first seam, to the second section by a second seam, and to the tube by a third seam.

2. Curtain airbag according to claim 1, characterised in that at least one of the seams is a sewn seam.

3. Curtain airbag according to claim 2, characterised in that all seams are sewn seams.

4. Curtain airbag according to claim 2, characterised in that the sewn seams are sealed by applying an adhesive.

5. Curtain airbag according to claim 1, characterised in that said tube being made of a least one cutting and being closed by at least one tube closing seam.

6. Curtain airbag according to claim 5, characterised in that said third seam and said tube closing seam are the same seam.

7. Curtain airbag according to claim 6, characterised in that first seam, second seam and tube closing seam are sections of a single seam.

8. Curtain airbag according to claim 1, characterised in that a receiving section for receiving a gas generator extends from the tube.

9. Curtain airbag according to claim 8, characterised in that receiving section and tube are made of a single cutting.

10. Curtain airbag according to claim 9, characterised in that said cutting is H-shaped.

11. Curtain airbag according to claim 9, characterised in that the receiving section further comprises a reinforcement layer.

12. Curtain airbag according to claim 1, characterised in that the tube is made of a single tube cutting showing a longitudinal slit.

13. Curtain airbag according to claim 12, characterised in that a receiving cutting is attached to a non-slit area of the tube cutting forming a receiving section for a gas generator.

14. Curtain airbag according to claim 1, characterised in that more that two gas chambers are present.

15. Method for making a curtain airbag comprising:
a first section having two side walls enclosing a first gas chamber;
a second section having two side walls enclosing a second gas chamber;
a tube made of a flexible material extending between the first and the second section and connecting the first gas chamber with the second gas chamber;
said tube being made of a cutting such that in a pre-assembled state a longitudinal edge of the tube is open;
tube connecting seams connecting the tube to the first and the second section respectively;
a closing seam closing the open longitudinal edge;
with the closing seam being applied after the tube connecting seams.
